(19) United States
(12) Patent Application Publication
(10) Pub. No.: US 2007/0181484 A1
(43) Pub. Date: Aug. 9, 2007

(54) Modular reverse osmosis water treatment system

(75) Inventors: Richard M. Reckin, Colgate, WI (US); Duane S. Freimuth, Franklin, WI (US); Kenneth J. Sieth, Delafield, WI (US)

Correspondence Address: QUARLES & BRADY LLP, 411 E. WISCONSIN AVENUE, SUITE 2040, MILWAUKEE, WI, 53202-4497, US

(73) Assignee: GE Osmonics, Inc.

(21) Appl. No.: 11/349,006

(22) Filed: Feb. 7, 2006

(51) Int. Cl. B01D 63/00

(52) U.S. Cl. 210/321.72; 210/443; 210/335

(57) ABSTRACT

A water treatment system includes a filter module and a reverse osmosis module secured to the filter module. The filter module contains two filter cartridges. The modular structure of the components enables the filter module to have the two filter cartridges connected as separate pre and post filters or connected in series as a single two-stage filter. Similarly the modularity permits multiple reverse osmosis modules to be connected is a daisy chain manner for increased treatment capacity. A novel bracket structure aligns ports of the filter module with corresponding ports on the reverse osmosis module.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention relates to apparatus for treating water to remove chemicals and other impurities, and more particularly to reverse osmosis water filtration systems.

2. Description of the Related Art

Reverse osmosis (RO) water treatment systems are often located under a countertop or sink in a kitchen or adjacent another place at which purified water is desired to be provided. The typical system comprises a pre-filter, that employs a conventional filter medium, to remove relatively large particles as all the water being treated passes through the medium. The water exits the pre-filter and enters a reverse osmosis unit.

Reverse osmosis is a method that separates solutes from a solution by causing the solvent (such as water) to float through a membrane at pressures higher than normal osmotic pressure. The osmosis phenomenon is manifested by the diffusion of a solvent through a semi-permeable membrane from a region of greater osmotic pressure to a region of lower osmotic pressure. As the solvent diffuses through the membrane, dissolved substances, such as salts, minerals and other contaminants, are left behind so that the region of lower osmotic pressure has a lower concentration of dissolved substances. The remaining dissolved substances are flushed from the higher pressure side of the membrane through a restricted drain aperture that creates the increased pressure within the unit. The fluid from the drain aperture may be sent to a sewer system or recycled through the water treatment system by a pump so that less water is wasted.

The treated water exiting the reverse osmosis unit may pass through an optional post-filter to improve the taste of that water. A tank may also be provided on the output of the treatment apparatus to store the purified water. When needed, the purified water is drawn from the tank.

Depending upon the characteristics of the untreated water at a particular installation, several pre-filters may be utilized and various pluralities of reverse osmosis units may be connected in parallel or series to treat the water and provide the necessary flow volume. Therefore, it is desirable to design components of the reverse osmosis water treatment system, which can be connected in various combinations and numbers to provide the necessary level of treatment required for a particular instillation.

### SUMMARY OF THE INVENTION

A water treatment system includes a filter module and a reverse osmosis module secured to the filter module. The filter module has a first manifold with a first filter cartridge and second filter cartridge mounted thereto. The first manifold has a filter inlet port and a filter outlet port. The first filter cartridge has a first inlet connected to the filter inlet port and has a first outlet. The second filter cartridge has a second inlet and having second outlet connected to the filter outlet port.

The first reverse osmosis module secured to the filter module and including a second manifold with a first RO inlet port, a first RO outlet port and a first drain port, the first RO inlet port being connected to the filter module and receiving water therefrom.

The modularity of the water treatment system enables several different configurations of the filter module to be connected to the first reverse osmosis module. In one version, the filter module is configured with the first filter cartridge acting as a pre-filter for the first reverse osmosis module and the second filter cartridge is connected as a post-filter. In another version, the two filter cartridge are coupled in series to function as a dual-stage pre-filter. The modularity also enables. multiple reverse osmosis modules to be connected in a daisy chain to increase the water treatment capability of the system.

### DESCRIPTION OF THE OF THE DRAWINGS

FIG. 1 is a block schematic diagram of a first water treatment system having a reverse osmosis module with a filter module containing a pre-filter and a post-filter;

FIG. 2 is an isometric view of the first water treatment system;

FIG. 3 is a cross sectional view through a first manifold at the upper portion of the filter module;

FIG. 4 is a cross sectional view vertically through the filter module;

FIG. 5 is a cross sectional view through a second manifold at the upper portion of the reverse osmosis module;

FIG. 6 is a block schematic diagram of a second water treatment system having a dual stage pre-filter module and two reverse osmosis modules;

FIG. 7 is an isometric view of the second water treatment system; and

FIG. 8 is a cross sectional view through the manifold of the dual stage pre-filter module.

### DETAILED DESCRIPTION OF THE INVENTION

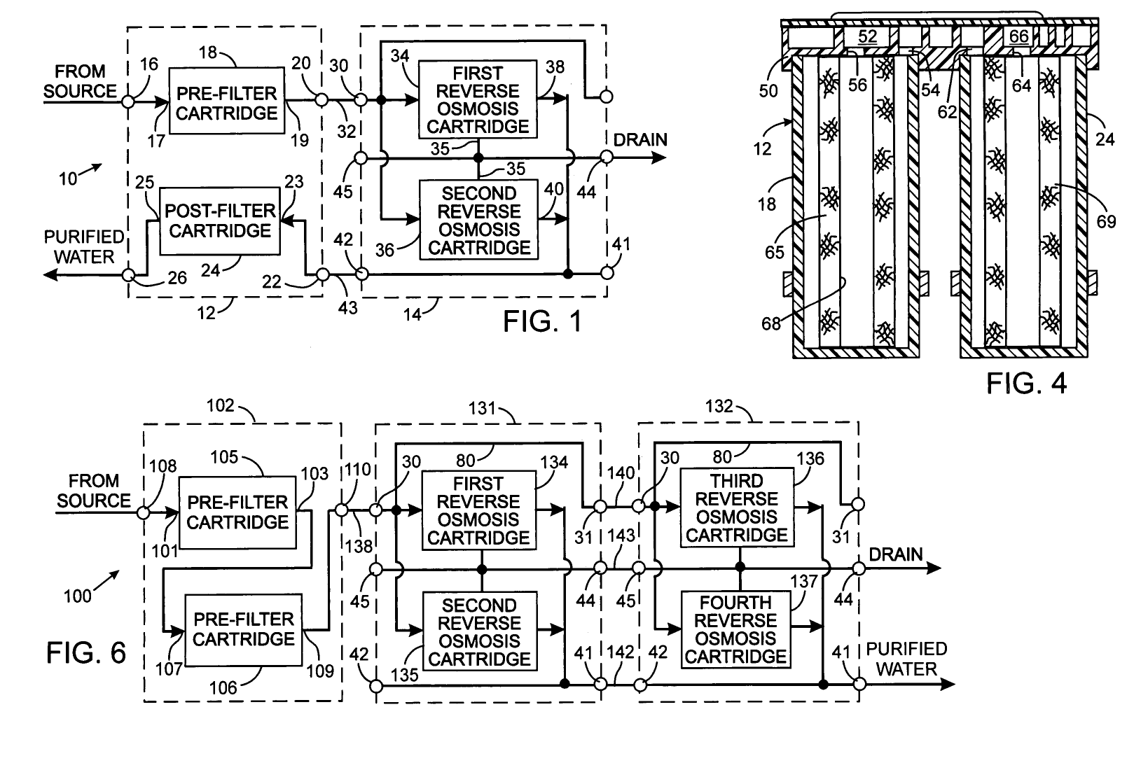

With initial reference to FIG. 1, a first water treatment system 10 comprises a filter module 12 and a reverse osmosis (RO) module 14. The filter module 12 receives untreated water from a source at a filter inlet port 16, which is connected to a first inlet 17 of a pre-filter cartridge 18. The pre-filter cartridge 18 contains a filter medium, such as a body of a spun fiber material, through which the water flows to trap relatively large particles. The output water from the pre-filter cartridge 18 flows from a first outlet 19 to a first intermediate port 20 of the filter module 12. The filter module also has a second intermediate port 22 that is connected to a second inlet 23 of a post-filter cartridge 24 which contains a filter medium, such as activated charcoal, to improve the taste and odor of the water. The output of the post-filter cartridge 24 flows from a second outlet 25 to a filter outlet port 26, which in the case of the first water treatment system 10 supplies purified water to the end user.

The first intermediate port 20 of the filter module 12 is connected by a tube 32 to a first RO inlet port 30 of the reverse osmosis module 14, which thereby receives water from the pre-filter cartridge 18. The reverse osmosis module 14 has first and second reverse osmosis cartridges 34 and 36 with inlets that are connected to the first RO inlet port 30. Each of the two reverse osmosis cartridges has a conventional semi-permeable membrane which filter water flowing there through. The treated water passes to cartridge outlets 38 and 40 that are connected to a first RO outlet port 42. The first RO outlet port 42 is coupled by a tube 43 to the second intermediate port 22 of the filter module 12. Therefore, the water treated in the two reverse osmosis cartridges 34 and 36 is fed back through the post-filter cartridge 24 to produce purified water at the filter outlet port 26. Each of the reverse osmosis cartridges 34 and 36 also has a drain outlet 35 from which some of the untreated water, carrying a high concentration of solutes, exits the cartridges. The drain outlets 35 are connected to first and second drain ports 44 of the reverse osmosis module 14.

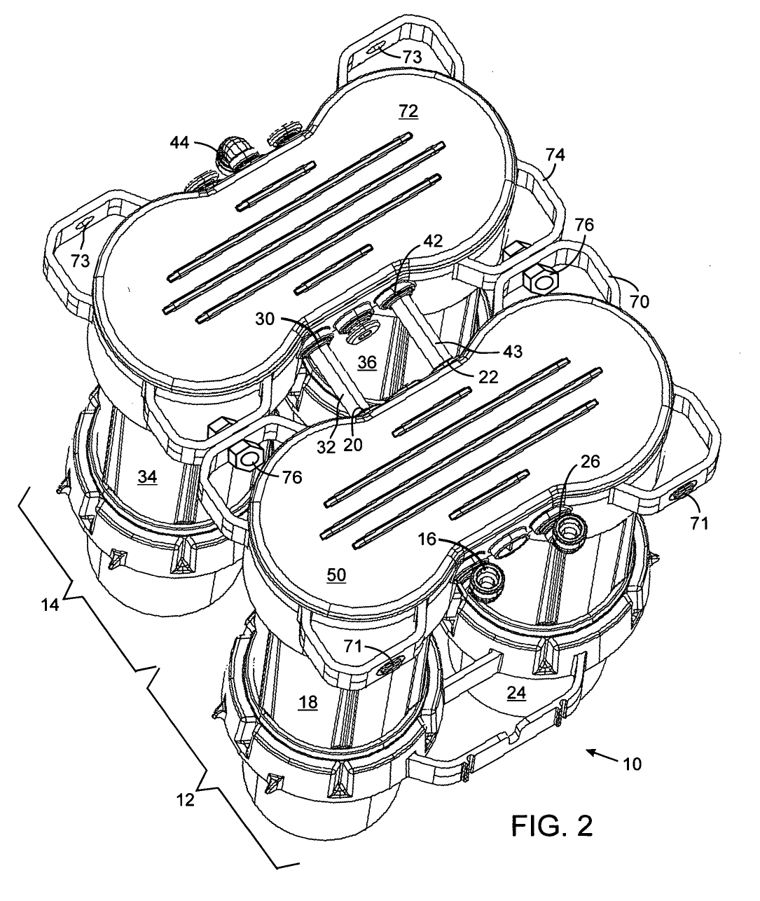

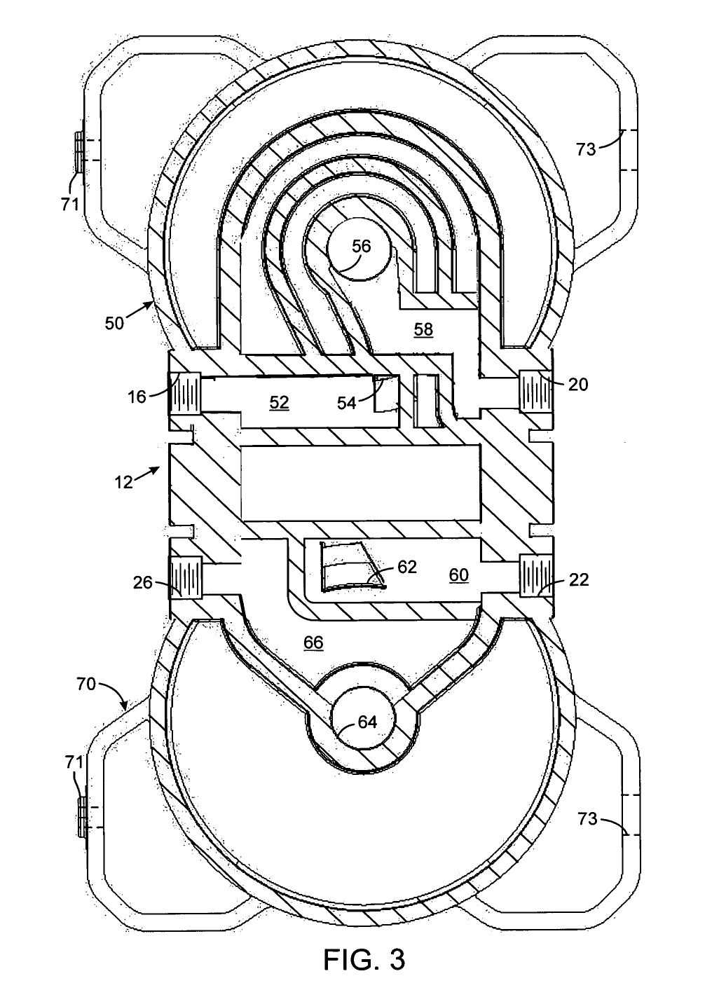

The first water treatment system 10 has a modular configuration, illustrated in FIG. 2, in which the filter module 12 and the reverse osmosis module 14 are attached abutting each other and are fluidly coupled. The two cylindrical filter cartridges 18 and 24 of the filter module 12 are mounted to a filter manifold 50 in which the filter inlet port 16, the filter outlet port 26, and the first and second intermediate ports 20 and 22 are located. The filter manifold 50 has internal passageways that interconnect selected ports with the pre-filter cartridge 18 and the post-filter cartridge 24. With reference to FIG. 3, the filter inlet port 16 opens into a first inlet passage 52 that leads to an aperture 54 through the bottom of the manifold and into the outer perimeter inside the pre-filter cartridge 18. A second aperture 56 through the bottom of the filter manifold 50 is located at the center of the pre-filter cartridge 18 and is within a first outlet passage 58 that leads to the first intermediate port 20.

With reference to FIGS. 3 and 4, the fluid entering the filter module 12 via the filter inlet port 16 flows through the first aperture 54 into the pre-filter cartridge 18 and around the filter medium 65 therein. The water in the pre-filter cartridge 18 passes through the filter medium 65 to the cartridge's central bore 68 and then upward through the second aperture 56, exiting the filter module 12 via the first intermediate port 20 on the opposite side of the filter module 12 from the filter inlet port 16.

The second intermediate port 22 on that opposite side of the filter module 12 communicates with a second inlet passage 60 that connects to a third aperture 62 in the bottom of the filter manifold 50 that opens inside the perimeter of the post-filter cartridge 24. After passing through the filter medium 69 in the post-filter cartridge 24, the water flows through a centrally located fourth aperture 64 in the bottom of the filter manifold 50. This fourth aperture 64 is connected by a second outlet passage 66 in the manifold 50 to the filter outlet port 26.

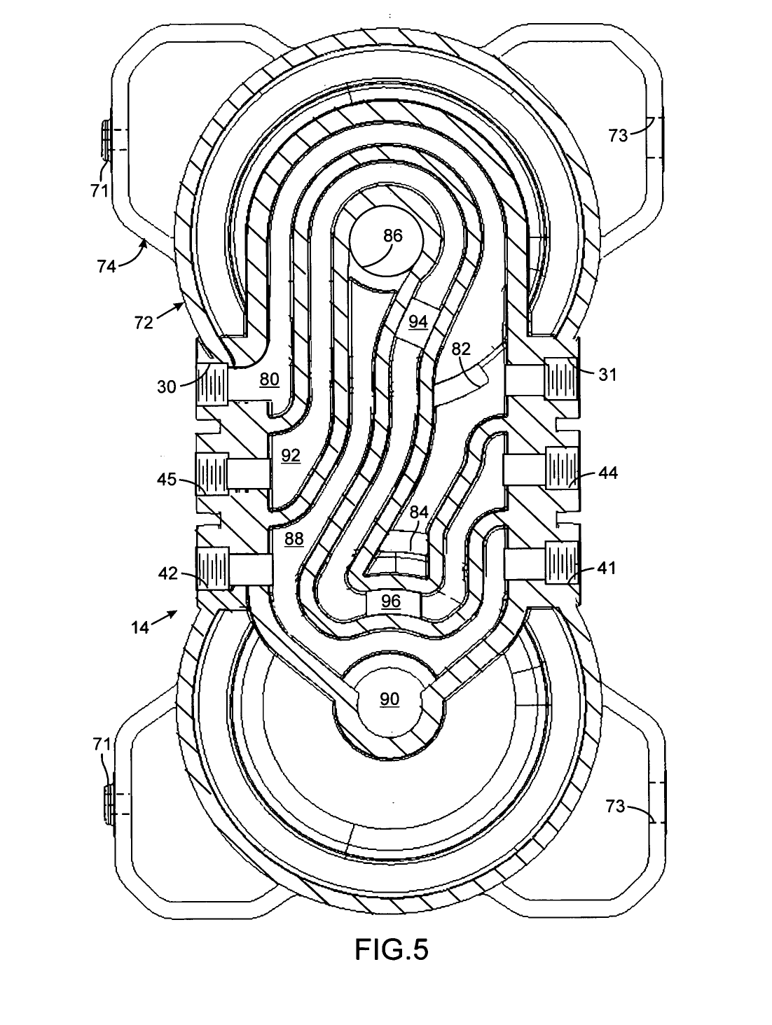

FIG. 5 illustrates the interior passages of a second manifold 72 that is part of the reverse osmosis module 14. The first RO inlet port 30 opens into an internal RO inlet passage 80 that communicates with a first RO aperture 82 through the bottom of the second manifold 72 and into the first reverse osmosis cartridge 34 in FIG. 2. The RO inlet passage 80 also opens through a second RO aperture 84 into the second reverse osmosis cartridge 36. The RO inlet passage 80 leads to a second RO inlet port 31 of the second manifold 72. Thus, the first and second RO apertures 82 and 84 provide the RO inlets of both reverse osmosis cartridges 34 and 36. The first and second RO inlet ports 30 and 31 are in direct fluid connection, which as used herein means that these ports are connected together by a conduit without any intervening element. The outlets 38 and 40 of those reverse osmosis cartridges 34 respectively communicate with first and second RO outlet apertures 86 and 90 in the bottom of the manifold 72. The RO outlet apertures 86 and 90 are connected by an RO outlet passage 88 to the first RO outlet port 42 and a second RO outlet port 41 on opposite sides of the second manifold 72. A drain passage 92 winds in a serpentine path through the second manifold thereby providing a direct fluid connection of the first and second drain ports 44 and 45. A pair of drain apertures 94 and 96 open through the bottom of the second manifold into the drain passage 92 which provide the drain outlets 35 of both reverse osmosis cartridges 34 and 36.

It should be noted that there is an inlet port, an outlet port and a drain port on the opposite sides of the reverse osmosis module 14 enabling several of the reverse osmosis modules to be connected side by side. Such daisy chaining enables a plurality of reverse osmosis cartridges to be connected in parallel for increased water purification capability. In a particular application, any unused ports are closed by a plug. The port arrangement also facilitates connecting the filter module 12 to a reverse osmosis module 14 in a modular configuration.

The individual modules of the water treatment system have brackets for attaching them together in a single structural assembly, as illustrated in FIG. 2. Specifically, the filter module 12 has a first bracket 70 extending around and projecting outwardly from four sides of the filter manifold 50. The second manifold 72 of the reverse osmosis module 14 includes a similar second bracket 74 extending around and outwardly there from on four sides. With reference to FIGS. 3 and 5, the first and second bracket assemblies 70 and 74 have keys 71, in the form of annular bosses, on one side and the opposite side has apertures 73 that are sized to receive the keys. Thus in the assembled first water treatment system 10, the bracket keys 71 of the reverse osmosis module 14 fit into the bracket apertures 73 of the filter module 12 to ensure proper orientation of those modules. Sets of nuts and bolts 76 pass through the bracket bosses and apertures to secure the adjacent modules together.

When the two modules 12 and 14 are secured directly together, the first intermediate port 20 of the filter module 12 aligns with the first RO inlet port 30 of the reverse osmosis module 14. As used herein, the term “secured directly” refers to two components, in this case the two modules 12 and 14, being attached with one component contacting the other, as opposed to each being attached separately to one or more intermediate elements which link the two components. As a result of that direct securing, a straight tube 32 is secured in each of those ports to provide a conduit between the two modules. The first RO outlet port 42 of the reverse osmosis module 14 similarly aligns with the second intermediate port 22 of the filter module 12 so that another straight tube 43 provides a conduit between those latter ports. The abutting brackets 70 and 74 provide a fixed spacing between the aligned ports so that the two tubes 32 and 43 can be supplied to the installer precut to the proper lengths. Each of the ports 16, 20, 22, 26, 30, 42 and 44 of the two modules 12 and 14 preferably utilize standard compression fittings.

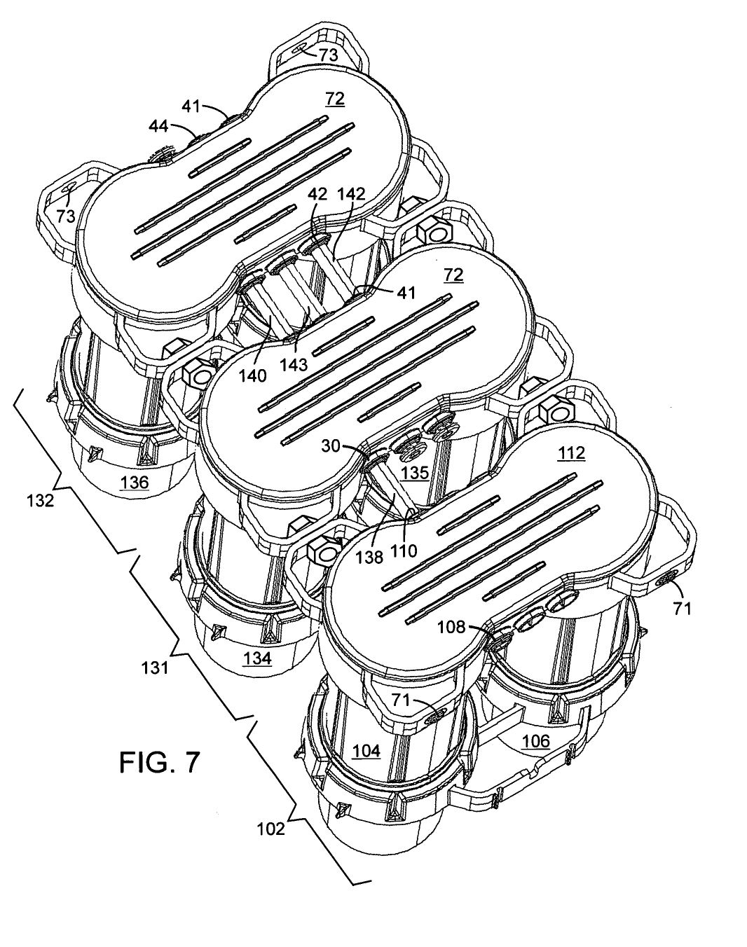

An example of another modular configuration of a second water treatment system 100 is depicted in FIGS. 6 and 7 in which a dual pre-filter module 102 is combined with two reverse osmosis modules 131 and 132 that are connected in tandem. Specifically, the dual pre-filter module 102 has two filter cartridges 105 and 106 coupled in series. Typically, the first pre-filter cartridge 105 has a medium that removes relatively large particles, whereas the medium of the second pre-filter cartridge 106 removes smaller particles.

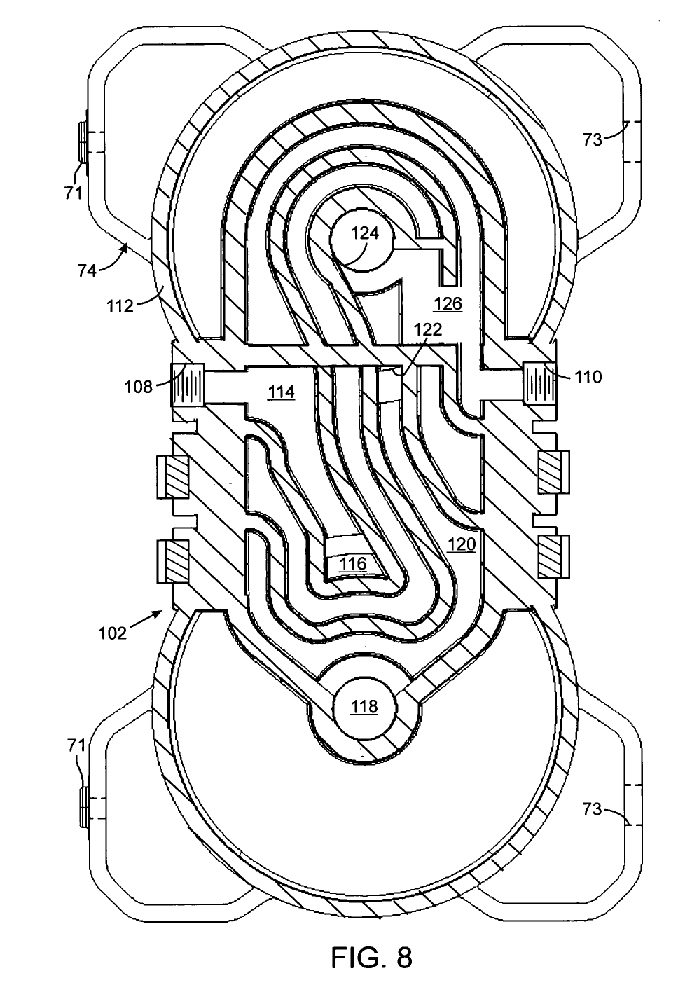

With reference to FIG. 8, the manifold 112 of the dual pre-filter module 102 has a filter inlet port 108 that receives the source water to be treated. An inlet passage 114 conveys the water from the filter inlet port 108 to a first inlet aperture 116 into the first inlet 101 (FIG. 6) of the first pre-filter cartridge 105 from which the water flows exits through a first outlet 103 back into the manifold via a first outlet aperture 118. An intermediate passage 120 connects the first outlet aperture 118 to a second inlet aperture 122 communicating with the second inlet 107 of the second pre-filter cartridge 106. The filtered water leaves the second pre-filter cartridge 106 via a second outlet 109 and a second outlet aperture 124 in the manifold, travels through an outlet passage 126, and exits the dual pre-filter module 102 via a filter outlet port 110.

Referring again to FIGS. 6 and 7, the filter outlet port 110 of the dual pre-filter module 102 is connected to the first RO inlet port 30 of the first reverse osmosis module 131 by a tube 138. Both reverse osmosis modules 131 and 132 have the same construction as the reverse osmosis module 14 of the first water treatment system 10, described previously. However in the modular configuration of the second water treatment system 100, the first and second reverse osmosis cartridges 134 and 135 of the first reverse osmosis module 131 and the third and fourth reverse osmosis modules 136 and 137 of the second reverse osmosis module 132 are all connected in parallel.

With respect to that parallel connection, the first RO inlet port 30 of the first reverse osmosis module 131 is coupled by the RO inlet passage 80 to that module's the second RO inlet port 31. That second RO inlet port 31 is connected by a tube 140 to the first RO inlet port 30 of the second reverse osmosis module 132. Similarly the second RO outlet port 41 of the first reverse osmosis module 131 is connected by a second tube 142 to the first RO outlet port 42 of the second reverse osmosis module 132, and the first drain port 44 of the first reverse osmosis module is coupled by a third tube 143 to the second drain port 45 on the second reverse osmosis module. The first drain port 44 of the second reverse osmosis module 132 is connected to a drain line for the second water treatment system 100 and the second RO outlet port 41 of the second reverse osmosis module 132 provides the outlet for the purified water.

The first and second reverse osmosis modules 131 and 132 also can be connected in other configurations. For example, the second RO outlet port 41 of the first reverse osmosis module 131 can be connected to the first RO inlet port 30 of the second reverse osmosis module 132 so that the two modules are in series. Alternatively, the first drain port 44 of the first reverse osmosis module can be coupled to the first RO inlet port 30 of the second reverse osmosis module 132. In this implementation, the second RO outlet port 41 of the first reverse osmosis module 131 is connected to the first RO outlet port 42 of the second reverse osmosis module 131. Here the second reverse osmosis module 132 processes some of the first RO module's drain water so that less water flows into the drain system thereby conserving water.

Additional reverse osmosis modules can be attached together. The modular configuration of the present water treatment systems enables various numbers of pre-filter cartridges, post-filter cartridges, and reverse osmosis cartridges to be connected together to provide the amount of water treatment capacity to satisfy the requirements of a particular installation.

The foregoing description was primarily directed to a preferred embodiment of the invention. Although some attention was given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

What is claimed is:

1. A water treatment system comprising:
a filter module with a first manifold with a first filter cartridge and second filter cartridge mounted thereto, the first manifold includes a filter inlet port and a filter outlet port, the first filter cartridge has a first inlet connected to the filter inlet port and has a first outlet, and the second filter cartridge has a second inlet and a second outlet that is connected to the filter outlet port; and
a first reverse osmosis module secured to the filter module and includes a second manifold with a first RO inlet port, a first RO outlet port and a first drain port, the first RO inlet port being connected to the filter module and receiving water therefrom.

2. The water treatment system as recited in claim 1 wherein the filter module further comprises a first intermediate port that is connected to the first outlet and to the first RO inlet port, and a second intermediate port that is connected to the second inlet and to the first RO outlet port.

3. The water treatment system as recited in claim 1 wherein the first outlet of the first filter cartridge is connected to the second inlet of the second filter cartridge, and the filter outlet port is connected to the first RO inlet port.

4. The water treatment system as recited in claim 1 wherein the first reverse osmosis module further comprises a first reverse osmosis cartridge and a second reverse osmosis cartridge mounted to the second manifold and each having a semi-permeable membrane.

5. The water treatment system as recited in claim 1 wherein the first reverse osmosis module further comprises a second RO inlet port in fluid communication with the first RO inlet port, and a second RO outlet port in fluid communication with the first RO outlet port.

6. The water treatment system as recited in claim 5 further comprising a second reverse osmosis module with another RO inlet port connected to the second RO inlet port of the first reverse osmosis module, and the second reverse osmosis module has another RO outlet port connected to the second RO outlet port of the first reverse osmosis module.

7. The water treatment system as recited in claim 6 wherein the second reverse osmosis module further comprises a first drain port, and a second drain port connected to the first drain port of the first reverse osmosis module.

8. The water treatment system as recited in claim 1 further comprising a second reverse osmosis module connected to the first reverse osmosis module and having another RO inlet port that receives water from the first reverse osmosis module.

9. The water treatment system as recited in claim 1 wherein the filter module includes a first mounting bracket and the first reverse osmosis module includes a second mounting bracket abutting the first mounting bracket.

10. The water treatment system as recited in claim 9 wherein one of the first mounting bracket and the second mounting bracket includes a first key, and the other of the first mounting bracket and the second mounting bracket includes a first aperture in which the first key is received to orient the filter module and the first reverse osmosis module with respect to each other.

11. The water treatment system as recited in claim 10 further comprising a second reverse osmosis module fluidly connected to the first reverse osmosis module and including a third mounting bracket abutting the second mounting bracket, wherein one of the second mounting bracket and the third mounting bracket includes a second key, and the other of the second mounting bracket and the third mounting bracket includes a second aperture in which the key is received to orient the first and second reverse osmosis modules with respect to each other.

12. A water treatment system comprising:
a filter module with a first manifold having an inlet port, an outlet port, and a first filter cartridge containing a filter medium and connected between the inlet port and the outlet port; and
a first reverse osmosis module secured to the filter module and including a second manifold with a first RO inlet port and a RO second inlet port in direct fluid connection, a first RO outlet port and a second RO outlet port in direct fluid connection, and a first drain port and a second drain port in direct fluid connection, the first reverse osmosis module having a first reverse osmosis cartridge attached to the second manifold between the first RO inlet port and the first RO outlet port;
wherein the outlet port of the filter module is aligned with and fluidly connected to the first RO inlet port of the first reverse osmosis module.

13. The water treatment system as recited in claim 12 wherein the first reverse osmosis module further comprises a second reverse osmosis cartridge mounted to the second manifold and connected fluidly in parallel with the first reverse osmosis cartridge.

14. The water treatment system as recited in claim 12 wherein the filter module further comprises a second filter cartridge containing another filter medium and connected fluidly in series with the first filter cartridge between the inlet port and the outlet port.

15. The water treatment system as recited in claim 12 further comprising a second reverse osmosis module with another RO inlet port connected to the second RO inlet port of the first reverse osmosis module, and another RO outlet port connected to the second RO outlet port of the first reverse osmosis module.

16. The water treatment system as recited in claim 12 wherein the filter module includes a first mounting bracket and the first reverse osmosis module includes a second mounting bracket contacting the first mounting bracket, wherein one of the first mounting bracket and the second mounting bracket includes a key, and the other of the first mounting bracket and the second mounting bracket includes an aperture in which the key is received to orient the filter module and the first reverse osmosis module with respect to each other.

17. A water treatment system comprising:
a filter module with including a first manifold having an inlet port, a first intermediate port, a second intermediate port, and an outlet port, the filter module having first filter cartridge fluidly connected between the inlet port and the first intermediate port, and having a second filter cartridge fluidly connected between the second intermediate port and the outlet port; and
a first reverse osmosis module secured to the filter module and including a second manifold with a first RO inlet port and a RO second inlet port in direct fluid connection, a first RO outlet port and a second RO outlet port in direct fluid connection, and a first drain port and a second drain port in direct fluid connection, the first reverse osmosis module having a first reverse osmosis cartridge mounted to the second manifold and fluidly connected between the first RO inlet port and the first RO outlet port;
wherein the first intermediate port of the filter module is aligned with and fluidly connected to the first RO inlet port of the first reverse osmosis module, and the first RO outlet port of the first reverse osmosis module is aligned with and fluidly connected to the second intermediate port of the filter module.

18. The water treatment system as recited in claim 17 wherein the first reverse osmosis module further comprises a second reverse osmosis cartridge mounted to the second manifold and connected fluidly in parallel with the first reverse osmosis cartridge.

19. The water treatment system as recited in claim 17 further comprising a second reverse osmosis module with another RO inlet port connected to the second RO inlet port of the first reverse osmosis module, and with another RO outlet port connected to the second RO outlet port of the first reverse osmosis module.

20. The water treatment system as recited in claim 19 wherein each of the first and second reverse osmosis modules further comprises a first drain port and a second drain port wherein the first drain port of the first reverse osmosis module is connected to the second drain port of the second reverse osmosis module.

21. The water treatment system as recited in claim 17 wherein the filter module includes a first mounting bracket and the first reverse osmosis module includes a second mounting bracket contacting the first mounting bracket, wherein one of the first mounting bracket and the second mounting bracket includes a key, and the other of the first mounting bracket and the second mounting bracket includes an aperture in which the key is received to orient the filter module and the first reverse osmosis module with respect to each other.
